(19) United States
(12) Patent Application Publication
(10) Pub. No.: US 2022/0076875 A1
(43) Pub. Date: Mar. 10, 2022

(54) THIN FILM INDUCTOR AND MANUFACTURING METHOD THEREOF

(71) Applicant: CHILISIN ELECTRONICS CORP., Hsinchu County (TW)

(72) Inventors: YI-CHUN JIN, TAOYUAN CITY (TW); MING-CHIEH CHIU, TAOYUAN CITY (TW)

(21) Appl. No.: 17/463,686

(22) Filed: Sep. 1, 2021

(30) Foreign Application Priority Data
Sep. 8, 2020 (TW) 109130753
Mar. 31, 2021 (TW) 110111947

(51) Int. Cl. H01F 27/28; H01F 17/00; H01F 27/32

(52) U.S. Cl. CPC H01F 27/2804; H01F 27/32; H01F 17/0013

(57) ABSTRACT

A thin film inductor and a manufacturing method thereof are provided. The thin film inductor includes a coil assembly, a first magnetic layer, and a second magnetic layer. The coil assembly includes a substrate, a first conductive wire, and a second conductive wire. The first and second conductive wires electrically connected to each other are disposed on first and second surfaces of the substrate, and each have a plurality of winding turns. The first and second conductive wires are embedded in the first and second magnetic layers, respectively. A part of the first magnetic layer fills into a gap between any two adjacent winding turns of the first conductive wire, and a part of the second magnetic layer fills into a gap between any two adjacent winding turns of the second conductive wire.

### CROSS-REFERENCE TO RELATED PATENT APPLICATION

This application claims the benefit of priority to Taiwan Patent Application Nos. 109130753 and 110111947, filed on Sep. 8, 2020 and Mar. 31, 2021, respectively. The entire contents of the above identified applications are incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor, and more particularly to a thin film inductor and a manufacturing method thereof.

### BACKGROUND OF THE DISCLOSURE

In a conventional thin film inductor of current technologies, wet printing processes are usually performed to fabricate magnetic layers that are used to cover a coil. However, in the conventional thin film inductor fabricated by the wet printing processes, a thickness of each magnetic layer cannot be effectively controlled, which may result in difficulty of mass production and low fabrication efficiency. Furthermore, since the magnetic layers of the conventional thin film inductor are made of the same material or have the same composition, the characteristics of the conventional thin film inductor cannot be improved effectively.

Accordingly, how the fabrication efficiency of the thin film inductor and the characteristics and quality of the thin film inductor can be improved by a structural design and modification of fabrication processes so as to overcome the abovementioned inadequacies, has become one of the important issues to be addressed in this industry.

### SUMMARY OF THE DISCLOSURE

In response to the above-referenced technical inadequacies, the present disclosure provides a thin film inductor and a manufacturing method thereof.

In one aspect, the present disclosure provides a thin film inductor. The thin film inductor includes a coil assembly, a first magnetic layer, a second magnetic layer, a third magnetic layer, and a fourth magnetic layer. The coil assembly includes a substrate, a first conductive wire disposed on a first surface of the substrate, and a second conductive wire disposed on a second surface of the substrate. The first and second conductive wires each have a plurality of winding turns. The first magnetic layer is disposed on the first surface, in which the first conductive wire is embedded in the first magnetic layer. A part of the first magnetic layer fills into a gap defined between any two adjacent ones of the winding turns of the first conductive wire. The second magnetic layer is disposed on the second surface, in which the second conductive wire is embedded in the second magnetic layer. A part of the second magnetic layer fills into a gap defined between any two adjacent ones of the winding turns of the second conductive wire. The third magnetic layer is disposed on the first magnetic layer, in which the first magnetic layer is disposed between the substrate and the third magnetic layer. The fourth magnetic layer is disposed on the second magnetic layer, in which the second magnetic layer is disposed between the substrate and the fourth magnetic layer. At least two of the first magnetic layer, the second magnetic layer, the third magnetic layer, and the fourth magnetic layer have different compositions.

In another aspect, the present disclosure provides a thin film inductor. The thin film inductor includes a coil assembly, a first magnetic layer, a second magnetic layer, and a magnetic core. The coil assembly includes a substrate, a first conductive wire disposed on a first surface of the substrate, and a second conductive wire disposed on a second surface of the substrate. The first conductive wire and the second conductive wire each have a plurality of winding turns. The first magnetic layer is disposed on the first surface, and the first conductive wire is embedded in the first magnetic layer. A part of the first magnetic layer fills into a gap defined between any two adjacent ones of the winding turns of the first conductive wire. The second magnetic layer is disposed on the second surface, and the second conductive wire is embedded in the second magnetic layer. A part of the second magnetic layer fills into a gap defined between any two adjacent ones of the winding turns of the second conductive wire. The magnetic core is disposed between the first magnetic layer and the second magnetic layer and located in a through hole of the substrate. The first conductive wire and the second conductive wire are arranged on the substrate to surround the through hole. At least two of the first magnetic layer, the second magnetic layer, and the magnetic core have different compositions.

In yet another aspect, the present disclosure provides a manufacturing method of a thin film inductor. The manufacturing method includes the steps of: providing a first magnetic mixed material and a second magnetic mixed material; drying the first magnetic mixed material and the second magnetic mixed material so as to form a first magnetic layer and a second magnetic layer; and embedding a first portion of a coil assembly into the first magnetic layer, and embedding a second portion of the coil assembly into the second magnetic layer. The first portion and the second portion each have a plurality of winding turns, a part of the first magnetic layer fills into a gap defined between any two adjacent ones of the winding turns of the first portion, and a part of the second magnetic layer fills into a gap defined between any two adjacent ones of the winding turns of the second portion.

Therefore, by virtue of “a part of the first magnetic layer filling into a gap defined between any two adjacent ones of the winding turns of the first conductive wire, and a part of the second magnetic layer filling into a gap defined between any two adjacent ones of the winding turns of the second conductive wire,” the characteristics and the quality of the thin film inductor can be improved. Furthermore, in the manufacturing method of the thin film inductor, by virtue of “drying the first magnetic mixed material and the second magnetic mixed material to respectively form the first magnetic layer and the second magnetic layer,” “embedding a first portion of a coil assembly in the first magnetic layer and embedding a second portion of the coil assembly in the second magnetic layer,” and “a part of the first magnetic layer filling into a gap defined between any two adjacent ones of the winding turns of the first portion, and a part of the second magnetic layer filling into a gap defined between any two adjacent ones of the winding turns of the second portion,” the fabrication efficiency, the characteristics and the quality of the thin film inductor can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective schematic view of a thin film inductor according to a first embodiment of the present disclosure.

FIG. 2 is a cross-sectional view taken along line II-II of FIG. 1.

FIG. 3 shows relationships between an inductance value (L) and a current in different examples 1-5 and a comparative example.

FIG. 4 shows the relationships between a percentage of an inductance value (L) to an initial inductance value (L0) and a current in different examples 1-5 and the comparative example.

FIG. 5 is a sectional schematic view of a thin film inductor according to a second embodiment of the present disclosure.

FIG. 6 is a sectional schematic view of a thin film inductor according to a third embodiment of the present disclosure.

FIG. 7 is a sectional schematic view of a thin film inductor according to a fourth embodiment of the present disclosure.

FIG. 8 shows relationships between an inductance value (L) and a current in different embodiments 1-4 of the present disclosure.

FIG. 9 shows the relationships between a percentage of an inductance value (L) to an initial inductance value (L0) and a current in different embodiments 1-4 of the present disclosure.

FIG. 10 is a sectional schematic view of a thin film inductor according to a fifth embodiment of the present disclosure.

FIG. 11 is a sectional schematic view of a thin film inductor according to a sixth embodiment of the present disclosure.

FIG. 12 is a flowchart of a manufacturing method of a thin film inductor according to a first embodiment of the present disclosure.

FIG. 13 is a schematic view of the thin film inductor in step S104 of the manufacturing method according to the first embodiment of the present disclosure.

FIG. 14 is a schematic view of the thin film inductor during the manufacturing method according to the first embodiment of the present disclosure.

FIG. 15 is another schematic view of the thin film inductor during the manufacturing method according to the first embodiment of the present disclosure.

FIG. 16 is yet another schematic view of the thin film inductor during the manufacturing method according to the first embodiment of the present disclosure.

FIG. 17 is yet another schematic view of the thin film inductor during the manufacturing method according to the first embodiment of the present disclosure.

FIG. 18 is a flowchart of a manufacturing method of a thin film inductor according to a second embodiment of the present disclosure.

FIG. 19 is a schematic view of the thin film inductor during the manufacturing method according to the second embodiment of the present disclosure.

FIG. 20 is another schematic view of the thin film inductor during the manufacturing method according to the second embodiment of the present disclosure.

FIG. 21 is yet another schematic view of the thin film inductor during the manufacturing method according to the second embodiment of the present disclosure.

FIG. 22 is a flowchart of a manufacturing method of a thin film inductor according to a third embodiment of the present disclosure.

FIG. 23 is a schematic view of the thin film inductor during the manufacturing method according to the third embodiment of the present disclosure.

FIG. 24 is another schematic view of the thin film inductor during the manufacturing method according to the third embodiment of the present disclosure.

FIG. 25 is a flowchart of a manufacturing method of a thin film inductor according to a fourth embodiment of the present disclosure.

FIG. 26 is a schematic view of the thin film inductor during the manufacturing method according to the fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

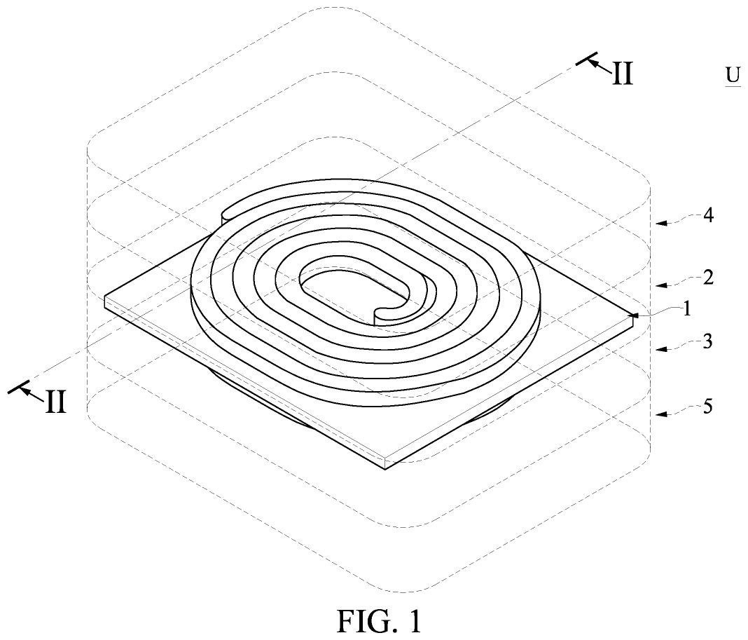

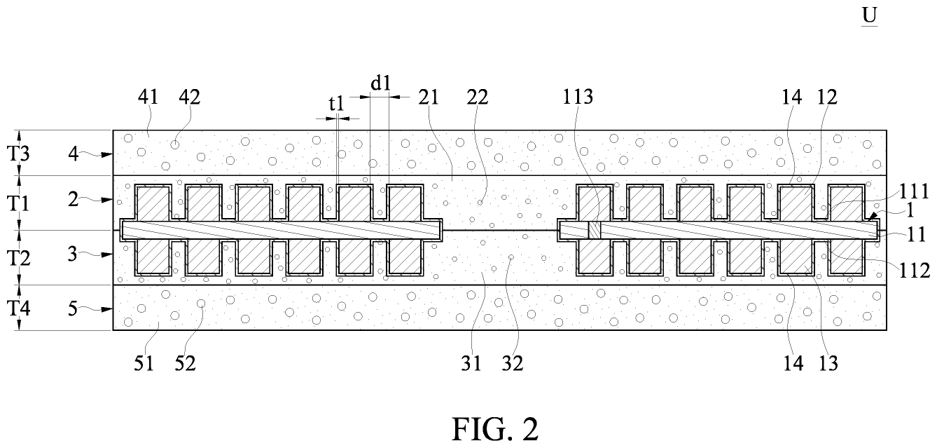

Reference is made to FIG. 1 to FIG. 2, in which FIG. 1 is a perspective schematic view of a thin film inductor according to a first embodiment of the present disclosure, and FIG. 2 is a cross-sectional view taken along line II-II of FIG. 1. A thin film inductor U is provided in the embodiment of the present disclosure, and the thin film inductor U includes a coil assembly 1, a first magnetic layer 2, a second magnetic layer 3, a third magnetic layer 4, and a fourth magnetic layer 5. The coil assembly 1 includes a substrate 11, a first conductive wire 12 disposed on a first surface 111 of the substrate 11, and a second conductive wire 13 disposed on a second surface 112 of the substrate 11. For example, the first surface 111 and the second surface 112 are two opposite surfaces of the substrate 11, and the substrate 11 can be selected from a copper clad laminate (CCL), such as a FR-4 (flame retardant 4) or FR-5 (flame retardant 5), a glass fiber unclad laminate, an epoxy magnetic material laminate, and so on. Furthermore, the first conductive wire 12 and the second conductive wire 13 are each in a spiral shape, and each have a plurality of winding turns, so as to generate an expected inductance. That is to say, the first and second conductive wires 12, 13 are electrically conductive and each have a predetermined wire pattern, but the present disclosure is not limited thereto. In one embodiment, a spacing d1 between any two adjacent ones of the plurality of winding turns of the first conductive wire 12 (or the second conductive wire 13) is at least 15 μm. In one referable embodiment, the spacing d1 ranges from 20 μm to 35 μm, but the present disclosure is not limited thereto.

Furthermore, it should be noted that the first conductive wire 12 and the second conductive wire 13 can be connected to each other through at least one conductive via 113 passing through the substrate 11. That is to say, the substrate 11 includes the at least one conductive via 113 extending from the first surface 111 to the second surface 112, and the at least one conductive via 113 is connected between the first and second conductive wires 12, 13. In one embodiment, the at least one conductive via 113 is connected between the innermost turn of the first conductive wire 12 and the innermost turn of the second conductive wire 13. However, the position of the at least one conductive via 113 is not limited in the present disclosure.

As mentioned above, preferably, the coil assembly 1 can further includes an insulating layer 14 covering the first conductive wire 12, the second conductive wire 13, and the substrate 11. As such, both of the first conductive wire 12 and the second conductive wire 13 can be insulated from the first magnetic layer 2, the second magnetic layer 3, the third magnetic layer 4, and the fourth magnetic layer 5, so as to prevent a short circuit.

It is worth mentioning that in the embodiments of the present disclosure, the insulating layer 14 does not fill up a gap between any two adjacent ones of the winding turns of the first conductive wire 12. Similarly, the insulating layer 14 does not fill up a gap between any two adjacent ones of the winding turns of the second conductive wire 13. Accordingly, a thickness t1 of the insulating layer 14 is less than the spacing d1 between any two adjacent ones of the winding turns of the first conductive wire 12 (or the second conductive wire 13). To be more specific, the spacing d1 between any two ones of the winding turns of the first conductive wire 12 (or the second conductive wire 13) is preferably two times greater than the thickness t1 of the insulating layer 14, i.e., the spacing d1, the thickness t1 of the insulating layer 14 satisfy the following relationship: d1>2t1. As such, a part of the first magnetic layer 2 can fill into the gap defined between any two adjacent ones of the winding turns of the first conductive wire 12. Similarly, a part of the second magnetic layer 3 can fill into the gap defined between any two adjacent ones of the second conductive wire 13.

In one embodiment, the spacing d1 is three times greater than the thickness t1 of the insulating layer 14. Specifically, the spacing can be four times greater than the thickness t1 of the insulating layer 14. That is to say, the thickness t1 can be adjusted according to the spacing d1, and the thickness t1 may range from 0.1 nm to 10 μm. For example, it is assumed that the spacing d1 is 20 μm, the thickness t1 of the insulating layer 14 is not more than 10 μm, preferably, not more than 3 μm. In one embodiment, the thickness t1 of the insulating layer 14 can range from 0.1 μm to 3 μm, which not only maintains an insulating property of the insulating layer 14, but also results in a better inductive characteristics of the thin film inductor U.

Furthermore, for example, the insulating layer 14 can be formed on the first and second conductive wires 12, 13 by an atomic layer deposition (ALD), a molecular layer deposition (MLD) or a chemical vapor deposition (CVD) process. The insulating layer 14 can be made of organic material, inorganic material, or organic-inorganic hybrid material, but the present disclosure is not limited thereto.

As mentioned previously, the first magnetic layer 2 is disposed on the first surface 111, and the first conductive wire 12 is embedded in the first magnetic layer 2. The second magnetic layer 3 is disposed on the second surface 112, and the second conductive wire 13 is embedded in the second magnetic layer 3. Furthermore, the third magnetic layer 4 is disposed on the first magnetic layer 2, and the first magnetic layer 2 is disposed between the substrate 11 and the third magnetic layer 4. The fourth magnetic layer 5 is disposed on the second magnetic layer 3, and the second magnetic layer 3 is disposed between the substrate 11 and the fourth magnetic layer 5. At least two ones of the first, second, third, and fourth magnetic layers 2, 3, 4, 5 have different compositions. In one embodiment of the present disclosure, the composition of the first magnetic layer 2 is the same as that of the second magnetic layer 3, and the composition of the third magnetic layer 4 is the same as that of the fourth magnetic composition 5. The composition of the first magnetic layer 2 is different from that of the third magnetic layer 4, and the composition of the second magnetic layer 3 is different from that of the fourth magnetic layer 5. It should be noted that the aforementioned “composition” can be material or property. Accordingly, the first magnetic layer 2, the second magnetic layer 3, the third magnetic layer 4, and the fourth magnetic layer 5 can be respectively made of different materials.

As mentioned above, for example, in the present disclosure, a permeability value of the third magnetic layer 4 can be greater than that of the first magnetic layer 2, and a permeability value of the fourth magnetic layer 5 can be greater than that of the second magnetic layer 3. The first and second magnetic layers 2, 3 have the same permeability value, and the third and fourth magnetic layers 4, have the same permeability value. Furthermore, for example, a core loss of the first magnetic layer 2 can be less than that of the third magnetic layer 4, and a core loss of the second magnetic layer 3 can be less than that of the fourth magnetic layer 5. However, it should be noted that the present disclosure is not limited to the abovementioned examples.

As mentioned above, for example, the first magnetic layer 2 includes a first filler 21 and a plurality of first particles 22 disposed in the first filler 21, the second magnetic layer 3 includes a second filler 31 and a plurality of second particles 32 disposed in the second filler 31, the third magnetic layer 4 includes a third filler 41 and a plurality of third particles 42 disposed in the third filler 41, and the fourth magnetic layer 5 includes a fourth filler 51 and a plurality of fourth particles 52 disposed in the fourth filler 51. However, it should be noted that in another embodiment, the first, second, third, and fourth magnetic layers 2, 3, 4, 5 may include another kind of particles in addition to the first, second, third, and fourth particles 22, 32, 42, 52, and the present is not limited to the examples provided herein. For example, for the present disclosure, under a situation where the composition of the first magnetic layer 2 is the same as that of the second magnetic layer 3, and the composition of the third magnetic layer 4 is the same as that of the fourth magnetic layer 5, the first filler 21 and the second filler 31 can be made of the same material or have the same property, and the third filler 41 and the fourth filler 51 can be made of the same material or have the same property. Furthermore, under a situation where the first and third magnetic layers 2, 4 respectively have different compositions, and the second and fourth magnetic layers 3, 5 respectively have different compositions, the first and third fillers 21, 41 can be made of different materials and have different properties, the second and fourth fillers 31, 51 can be made of different materials and have different properties, the first and third particles 22, 42 can be made of different materials and have different properties, and the second and fourth particles 32, 52 can be made of different materials and have different properties.

As mentioned above, for example, the first filler 21, the second filler 31, the third filler 41, and the fourth filler 51 can be made of thermosetting polymer or light-activated curing polymer, such as, but not limited to, epoxy or UV curable adhesive. In addition, for example, each one of the first particles 22, the second particles 32, the third particles 42, and the fourth particles 52 can be magnetic powder, and the material of the magnetic powder may be, for example, Si—Fe alloy, Fe—Si—Cr alloy, Fe—Si—Al alloy, iron, ferrite, amorphous material, nanocrystalline material, or any combination thereof, and the present disclosure is not limited to the examples provided herein. Furthermore, the abovementioned “composition” may mean the size of each of the first particles 22, the second particle 32, the third particle 42, and the fourth particle 52.

As mentioned above, for example, the sizes of the first particles 22 are smaller than those of the third particles 42, and sizes of the second particles 32 are smaller than those of the fourth particles 52, but the present disclosure is not limited thereto. The smaller the size of each one of the first to fourth particles 22, 32, 42, 52 is, the lower the permeability value is. As such, by using the first and second particles 22, 32 having smaller sizes in the first magnetic layer 2 and the second magnetic layer 3, respectively, a saturation current of the thin film inductor U can be increased. By using the third and fourth particles 42, 52 having larger sizes in the third magnetic layer 4 and the fourth magnetic layer 5, respectively, the inductance of the thin film inductor U can be increased.

It is worth mentioning that as shown in FIG. 2, a part of the first magnetic layer 2 can fill into the gap defined between any two adjacent ones of the winding turns of the first conductive wire 12. Similarly, a part of the second magnetic layer can fill into the gap defined between any two adjacent ones of the winding turns of the second conductive wire 13. In one preferable embodiment, the sizes of the first particles 22 are required to be small enough to be located in the gap defined between any two adjacent ones of the winding turns of the first conductive wire 12. Similarly, the sizes of the second particles 32 are required to be small enough to be located in the gap defined between any two adjacent ones of the winding turns of the second conductive wire 13. Specifically, it is assumed that each of the first particles 22 (or the second particles 32) has a diameter “r,” the diameter “r”, the spacing d1, and the thickness t1 of the insulating layer 14 can satisfy the following relationship: r<(d1−2t1).

Furthermore, since the first and second conductive wires 12, 13 are respectively embedded in the first and second magnetic layers 2, 3, selecting the first and second particles 22, 32 having smaller sizes can prevent the structures of the first and second conductive wires 12, 13 from being damaged.

Accordingly, the sizes of the first and second particles 22, 32 can be determined according to the spacing d1 and the thickness t1 of the insulating layer 14. For example, the size of the first particle 22 can range from 0.5 μm to 15 μm, the size of the second particle 32 can range from 0.5 μm to 15 μm, the size of the third particle 42 can range from 2 μm to 50 μm, and the size of the fourth particle 52 can range from 2 μm to 50 μm, but the present disclosure is not limited thereto. Preferably, the size of the first particle 22 ranges from 1 μm to 5 μm, and the size of the third particle 42 ranges from 5 μm to 15 μm, but the present disclosure is not limited thereto.

Furthermore, it should be noted that when the first, second, third, and fourth magnetic layers 2, 3, 4, 5 each further include another kind of particles that are made of different magnetic materials in addition to the first, second, third, and fourth particles, 22, 32, 42, 52.

Accordingly, in the present disclosure, the characteristics of the thin film inductor U can be modified by adjusting the compositions of the first, second, third and fourth magnetic layers 2, 3, 4, 5. For example, in one embodiment, when the thin film inductor U is required to have a higher withstand current and a lower core loss, the materials of the first and second magnetic layers 2, 3 can be carbon-based iron powder, and the materials of the third and fourth magnetic layers, 4, 5 can be carbon-based iron powder or amorphous material. Moreover, when the thin film inductor U is required to have a higher permeability value and a lower DC resistance, the materials of the first and second magnetic layers 2, 3 can be Fe—Si—Cr alloy, and the materials of the third and fourth magnetic layers 4, 5 can be Fe—Si—Cr alloy or amorphous material. However, the present disclosure is not limited to the examples provided herein.

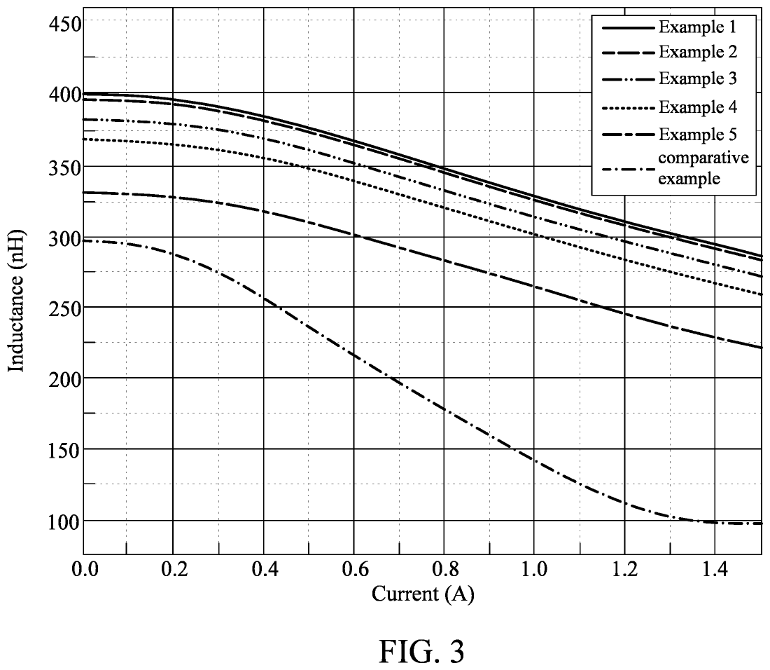

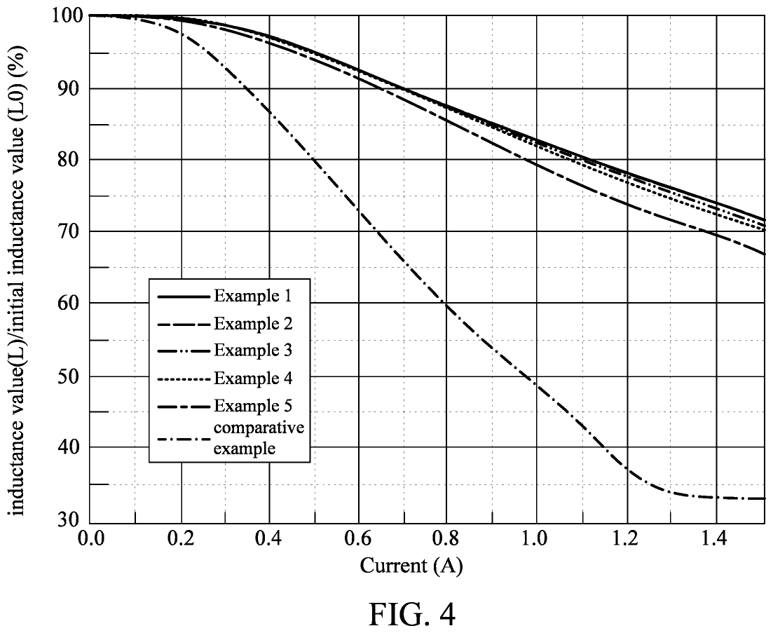

Reference is made to FIG. 3. FIG. 3 shows relationships between an inductance value (L) and a current in different examples 1-5 and a comparative example, and FIG. 4 shows the relationships between a percentage of an inductance value (L) to an initial inductance value (L0) and a current in different examples 1-5 and the comparative example.

To be more specific, the structure of the thin film inductor U shown in FIG. 2 is taken as an example to be simulated. In examples 1-5 and the comparative example, the insulating layers 14 respectively have different thicknesses. However, the other parameters, such as a thickness, line width, and spacing d1 of each of the first and second conductive wires 12, 13, and the materials of the first to fourth magnetic layers 2-5 are the same in examples 1-5 and the comparative example. The spacing d1 between any two adjacent ones of the winding turns of the first and second conductive wires 12, 13 in each of the examples 1-5 is 20 μm. Furthermore, the thicknesses of the insulating layers 14 in examples 1-5 are respectively 0.1 μm, 1 μm, 3 μm, 5 μm, and 10 μm. In the comparative example, the insulating layer completely fills up the gap defined between any two adjacent ones of the winding turns of the first and second conductive wires.

That is to say, in the examples 1-5, the first magnetic layer 2 fills into the gap defined between any two adjacent ones of the winding turns of the first conductive wire 12, and the second magnetic layer 3 fills into the gap defined between any two adjacent ones of the winding turns of the second conductive wire 13. As the thickness t1 of the insulating layer 14 increases, the part of the first magnetic layer 2 (or the second magnetic layer 3) filling into the gap defined between any two adjacent ones of the winding turns of the first conductive wire 12 (or the second conductive wire 13) is decreased. Reference is made to the following Table 1, in which the thicknesses t1 of the insulating layers 14 and initial inductance values (L0) in examples 1-5 and the comparative example before a current is applied are listed.

TABLE 1

| | thickness of the insulating | initial inductance |
|---|---|---|
| | layer (μm) | value L0 (nH) |
| Example 1 | 0.1 | 400.2 |
| Example 2 | 1 | 396.3 |
| Example 3 | 3 | 382.4 |
| Example 4 | 5 | 368.5 |
| Example 5 | 10 | 330.6 |
| comparative | completely filling up the gap | 297.5 |
| example | | |

Reference is made to Table 1, which is to be read in conjunction with FIG. 3. The larger the thickness of the insulating layer 14, the lower the initial inductance value L0 of the thin film inductor U. Reference is made to FIG. 3. Compared to examples 1-5, when the insulating layer 14 completely fills up the gap defined between any two adjacent ones of the winding turns of the first and second conductive wires 12, 13, the initial inductance value L0 of the thin film inductor in the comparative example significantly decreases. Accordingly, in the embodiments of the present disclosure (the examples 1-5), the smaller the thickness t1 of the insulating layer 14, the higher the initial inductance value L0 of the thin film inductor U.

However, compared to examples 1-4, the initial inductance value of the thin film inductor in example 5, in which the thickness t1 (10 μm) of the insulating layer 14 is half the spacing d1 (20 μm), is obviously lower. Accordingly, in one preferable embodiment of the present disclosure, the thickness t1 of the insulating layer 14 preferably does not exceed 5 μm, and more preferably ranges from 0.1 μm to 3 μm.

Furthermore, as shown in FIG. 3, as the applied current is increased, all of the inductance values of the examples 1-5 decrease. However, each of the inductance values of the thin film inductors in examples 1-5 decreases more slowly. Compared to examples 1-5, the inductance value of the thin film inductor in comparative example rapidly decreases with the increasing applied current.

Reference is made to FIG. 4, which shows the relationships between a percentage of an inductance value (L) to an initial inductance value (L0) and a current in examples 1-5 and the comparative example. That is to say, the inductance values (L) of each of the thin film inductors of examples 1-5 and the comparative example are measured under different currents applied to the thin film inductors of examples 1-5 and the comparative example. The inductance values (L) are respectively divided by the initial inductance values (L0) of the thin film inductors in examples 1-5 and the comparative example, so as to obtain the percentages under different applied currents.

It should be noted that the more slowly the percentage of the inductance value (L) to the initial inductance values (L0) decreases as the applied current increases, the greater the saturation current (Isat) of the thin film inductor is. As shown in FIG. 4, as the applied current increases, the percentages of the inductance value (L) to the initial inductance values (L0) in examples 1-4 decrease respectively with slopes that are similar to one another. Therefore, the difference between any two ones of the saturation currents (Isat) of the thin film inductors in examples 1-4 is not large and obvious. Furthermore, as shown in FIG. 4, for example 5, a decreasing gradient (or slope) in the percentage of the inductance value (L) to the initial inductance values (L0) with the increasing applied current greatly increases.

As shown in FIG. 4, compared to examples 1-5, as the applied current increases, the percentage of the inductance value (L) to the initial inductance values (L0) in the comparative example more significantly decreases. That is to say, compared to the thin film inductors in examples 1-5, the saturation current of the thin film inductor in the comparative example is much lower. According to the abovementioned experimental results, when the insulating layer 14 does not fill up the gap defined between any two adjacent winding turns of the first conductive wire 12 (or the second conductive wire 13), i.e., examples 1-5, the thin film inductor U have a higher initial inductance value L0, a higher saturation current (Isat), and better characteristics.

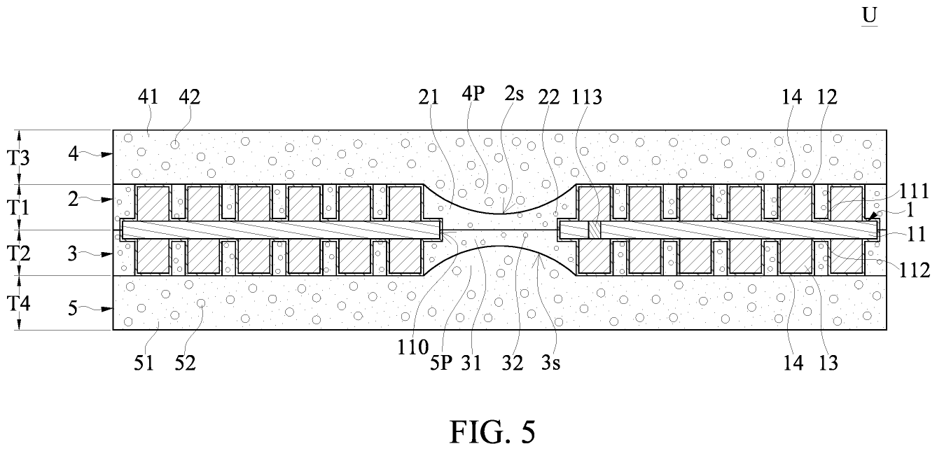

Reference is made to FIG. 5, which is a sectional schematic view of a thin film inductor according to a second embodiment of the present disclosure. Compared to the embodiment shown in FIG. 2, the first magnetic layer 2 of the thin film inductor U in the instant embodiment has a first curved surface 2s, and the second magnetic layer 3 has a second curved surface 3s. The first curved surface 2s and the second curved surface 3s are respectively located at a central portion of the first magnetic layer 2 and a central portion of the second magnetic layer 3, and the first curved surface 2s and the second curved surface 3s respectively correspond to a through hole 110 of the substrate 11 in position. Specifically, the first curved surface 2s and the second curved surface 3s are both concave surfaces recessed toward the substrate 11. Furthermore, the first curved surface 2s corresponds in position to the second curved surface 3s. To be more specific, orthogonal projections of the first curved surface 2s and the second curved surface 3s overlap with each other in a thickness of the substrate 11.

That is to say, the first curved surface 2s of the first magnetic layer 2 and the second curved surface 3s of the second magnetic layer 3 respectively define two recess regions. Furthermore, the third magnetic layer 4 has a protrusion portion 4P protruding from an inner surface thereof. The protrusion portion 4P is located at a side of the third magnetic layer 4 closer to the substrate 11, and fills into the recess region defined by the first curved surface 2s of the first magnetic layer 2. Similarly, the fourth magnetic layer 5 also has a protrusion portion 5P protruding from an inner surface thereof. The protrusion portion 5P is located at a side of the fourth magnetic layer 5 closer to the substrate 11, and the protrusion portion 5P fills into the recess region defined by the second curved surface 3s of the second magnetic layer 3.

Furthermore, in the instant embodiment, a part of a surface of the insulating layer 14 covering the first conductive wire 12 is not covered by the first magnetic layer 2 and is coplanar with a surface of the first magnetic layer 2. Accordingly, the third magnetic layer 4 is in contact with the portion of the insulating layer 14 (covering the first conductive wire 12) and the first magnetic layer 2. Similarly, a part of a surface of another insulating layer 14 covering the second conductive wire 13 is not covered by the second magnetic layer 3 and is coplanar with a surface of the second magnetic layer 3. The fourth magnetic layer 5 is in contact with the another insulating layer 14 (covering the second conductive wire 13) and the second magnetic layer 3. However, the present disclosure is not limited to the aforementioned example.

The third magnetic layer 4 has a third thickness T3 that is one to ten times a first thickness T1 of the first magnetic layer 2, and the fourth magnetic layer 5 has a fourth thickness T4 that is one to ten times the second thickness T2 of the second magnetic layer 3. In the instant embodiment, the first thickness T1 of the first magnetic layer 2 is less than the third thickness T3 of the third magnetic layer 4, and a second thickness T2 of the second magnetic layer 3 is less than the fourth thickness T4 of the fourth magnetic layer 5.

Additionally, the first thickness T1 of the first magnetic layer 2 is about 1 to 1.5 times a thickness of the first conductive wire 12, and the second thickness T2 of the second magnetic layer 3 is about 1 to 1.5 times a thickness of the second conductive wire 13. For example, when the thickness of the first conductive wire 12 (or the second conductive wire 13) is 50 μm, the first thickness T1 (or the second thickness T2) of the first magnetic layer 2 (or the second magnetic layer 3) can range from 50 μm to 75 μm.

In one embodiment, the permeability value of the first magnetic layer 2 is less than that of the third magnetic layer 4, and the permeability value of the second magnetic layer 3 is less than that of the fourth magnetic layer 5. It is worth mentioning that under a condition that the first and second magnetic layers 2, 3 each have a lower permeability value, the thin film inductor U has a higher saturation current, but has a relatively lower inductance. Accordingly, in the instant embodiment, by decreasing the thicknesses of the first and second magnetic layers 2, 3, the first and second magnetic layers 2, 3 each have the recess region formed therein. By respectively filling the protrusion portions 4P, 5P of the third and fourth magnetic layers 4, 5 each having a higher permeability value into the recess regions of the first and second magnetic layers 2, 3, the inductance of the thin film inductor U can be improved without compromising or decreasing the saturation current thereof, thereby optimizing the characteristics of the thin film inductor U.

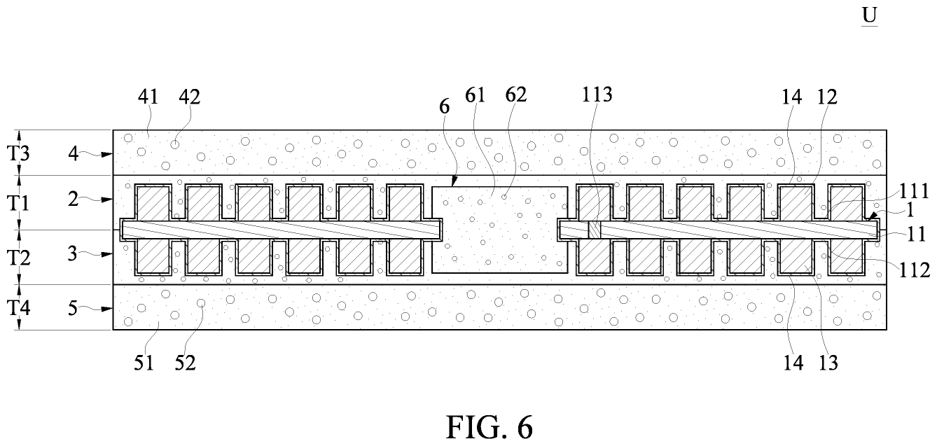

Reference is made to FIG. 6, which is a sectional schematic view of a thin film inductor according to a third embodiment of the present disclosure. Compared FIG. 6 with FIG. 2, the most obvious difference is that in the embodiment shown in FIG. 6, the thin film inductor U can further include a magnetic core 6. The magnetic core 6 is disposed between the first and second magnetic layers 2, 3 and located in a through hole 110 of the substrate 11, and the first conductive wire 12 and the second conductive wire 13 disposed on the substrate 11 surround the through hole 110. In other words, in the embodiment shown in FIG. 2, the through hole 110 of the substrate 11 is filled with the first and second magnetic layers 2, 3, but in the embodiment shown in FIG. 6, the through hole 110 is filled with the magnetic core 6. At least two of the first magnetic layer 2, the second magnetic layer 3, the third magnetic layer 4, the fourth magnetic layer 5, and the magnetic core 6 have different compositions. Preferably, for the present disclosure, the composition of the first magnetic layer 2 is the same as that of the second magnetic layer 3, and different from that of the magnetic core 6. However, it should be noted that in another embodiment, the magnetic core 6, the first magnetic layer 2, and the second magnetic layer 3 have the same composition, i.e., the embodiment shown in FIG. 2, but the present disclosure is not limited thereto.

As mentioned above, for example, in the embodiment shown in FIG. 6, the magnetic core 6 includes a fifth filler 61 and a plurality of fifth particles 62 disposed in the fifth filler 61, and a size of each of the fifth particles 62 can be smaller than that of each of the first particles 22. Furthermore, the material of the fifth filler 61 can be thermosetting polymer, such as, but not limited to, epoxy. Moreover, the fifth particles 62 can be magnetic powder, and the material of the magnetic powder may be, but not limited to, Si—Fe alloy, Fe—Si—Cr alloy, Fe—Si—Al alloy, iron, ferrite, amorphous material, nano-crystalline material. However, it should be noted that the present disclosure is not limited to the abovementioned examples. Furthermore, it should be noted that the structures of the coil assembly 1, the first magnetic layer 2, the second magnetic layer 3, the third magnetic layer 4, and the fourth magnetic layer 5 shown in FIG. 6 have been mentioned in previous descriptions, and will not be reiterated herein.

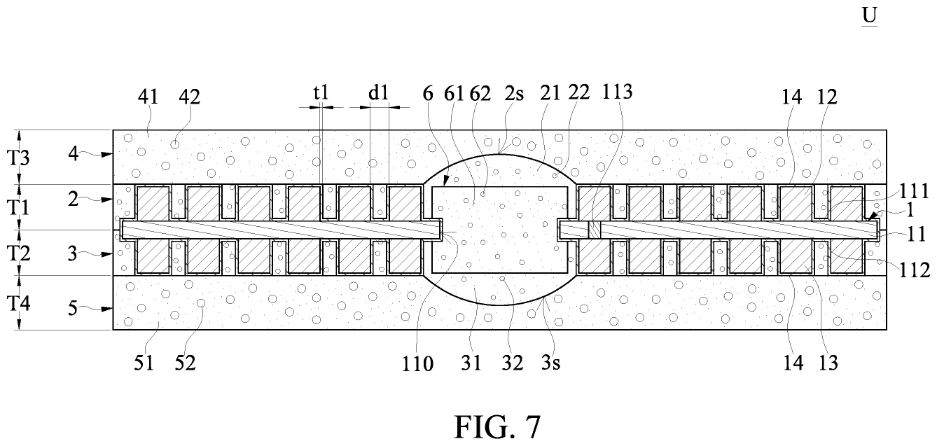

Subsequently, referring to FIG. 7, FIG. 7 is a sectional schematic view of a thin film inductor according to a fourth embodiment of the present disclosure. Compared to the embodiment shown in FIG. 6, the first magnetic layer 2 of the thin film inductor U has a first curved surface 2s, and the second magnetic layer 3 has a second curved surface 3s. The first surface 2s and the second surface 3s are respectively located at a central portion of the first magnetic layer 2 and a central portion of the second magnetic layer 3, and respectively correspond to the magnetic core 6 in position. To be more specific, the first and second curved surfaces 2s, 3s are convex surfaces, and the orthogonal projections of the first curved surface 2s, the second curved surface 3s, and the magnetic core 6 overlap with one another in the thickness direction of the substrate 11.

Specifically, the first magnetic layer 2 can be divided into a peripheral portion covering the first conductive wire 12 and the central portion covering the magnetic core 6, and the central portion protrudes from the peripheral portion and has the convex surface (the first curved surface 2s). Similarly, the second magnetic layer 3 can be divided into a peripheral portion covering the second conductive wire 13 and the central portion covering the magnetic core 6, and the central portion protrudes from the peripheral portion and has the convex surface (the second curved surface 3s). Accordingly, the first curved surface 2s protrudes from the first conductive wire 12, and the second curved surface 3s protrudes from the second conductive wire 13.

As shown in FIG. 7, the third magnetic layer 4 has a concave region corresponding to the first curved surface 2s, and the fourth magnetic layer 5 has another concave region corresponding to the second curved surface 3s. However, each one of the outer surfaces of the third and fourth magnetic layers 4, 5 is still a flat surface. That is to say, in the instant embodiment, each of the third and fourth magnetic layers 4, 5 has different thicknesses respectively in different region. Specifically, the third magnetic layer 4 (or the fourth magnetic layer 5) has a smaller thickness in the concave region than that in other regions.

Furthermore, in the instant embodiment, the first thickness T1 of the first magnetic layer 2 is about 1 to 1.5 times a thickness of the first conductive wire 12, and the second thickness T2 is about 1 to 1.5 times a thickness of the second conductive wire 13.

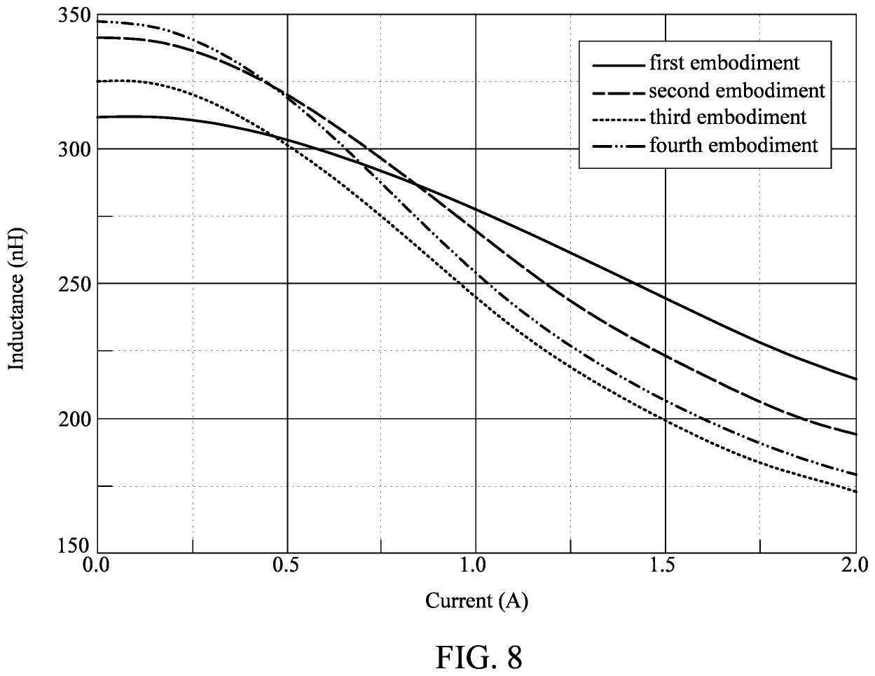

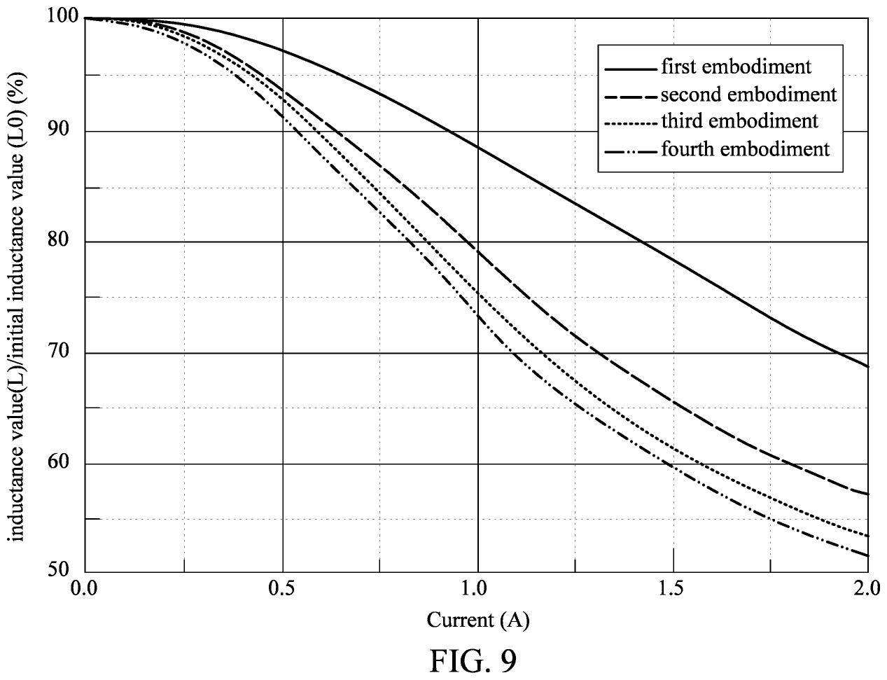

Reference is made to FIG. 8 and FIG. 9. FIG. 8 shows relationships between an inductance value (L) and a current in different embodiments 1-4 of the present disclosure, and FIG. 9 shows the relationships between a percentage of an inductance value (L) to an initial inductance value (L0) and a current in different embodiments 1-4 of the present disclosure.

It should be noted that the conditions of the first and second magnetic layers 2, 3 having the same permeability value and the third and fourth magnetic layers 4, 5 having the same permeability value are set for simulation, in which the permeability value of the first magnetic layer 2 is lower than that of the third magnetic layer 4. Furthermore, in the third and fourth embodiments, the permeability value of the magnetic core 6 is set to be the same as that of the third magnetic layer 4 for simulation, i.e., the magnetic core 6 has a higher permeability value than that of the first or second magnetic layers 2, 3.

The simulation results are shown in FIG. 8, in which the thin film inductor U of the first embodiment has the lowest initial inductance value, and the thin film inductor U of the forth embodiment has the highest initial inductance value. However, the initial inductance value of the thin film inductor U in the second embodiment is greater than that of the thin film inductor U in the third embodiment.

Furthermore, compared to the second to fourth embodiments, as the applied current increases, the percentage of the inductance value (L) to the initial inductance value (L0) of the thin film inductor U in the first embodiment decreases more slowly, which represents that the thin film inductor U of the first embodiment has a relatively higher saturation current (Isat).

Reference is made to FIG. 9. The more slowly the percentage of the inductance value (L) to the initial inductance values (L0) decreases as the applied current increases, the greater the saturation current (Isat) of the thin film inductor. Based on the simulation results, it can be observed that the thin film inductor U of the first embodiment has a greatest saturation current, and the thin film inductor U of the fourth embodiment has a lowest saturation current. However, the thin film inductor U of the second embodiment has a higher saturation current than that of the thin film inductor U of the third embodiment.

It should be noted that generally speaking, the higher the permeability value of the material located at a central region (a region surrounded by the first and second conductive wires 12, 13) of the coil assembly 1, the higher the initial inductance value. Furthermore, in general, the thin film inductor having a higher initial inductance value usually has a relatively lower saturation current. However, based on the simulation results, the thin film inductor U of the third embodiment includes the magnetic core 6 located at the central region and having a higher permeability value, but the initial inductance value of the thin film inductor U in the second embodiment is higher than that of the thin film inductor U in the third embodiment.

Furthermore, referring to FIG. 8 and FIG. 9, compared to the thin film inductor U in the third embodiment, the thin film inductor U in the second embodiment has a relatively higher initial inductance value and a higher saturation current. Specifically, for both of the thin film inductors of the second and fourth embodiments, the third and fourth magnetic layers 4, 5 are directly connected to the insulating layer 14 that covering the first and second conductive wires 12, 13, which causes a distribution of the magnetic field to be optimized, and then results in a higher initial inductance value. That is to say, the thin film inductors U of the second and fourth embodiments both have unexpected and better electric performances by the structural designs thereof.

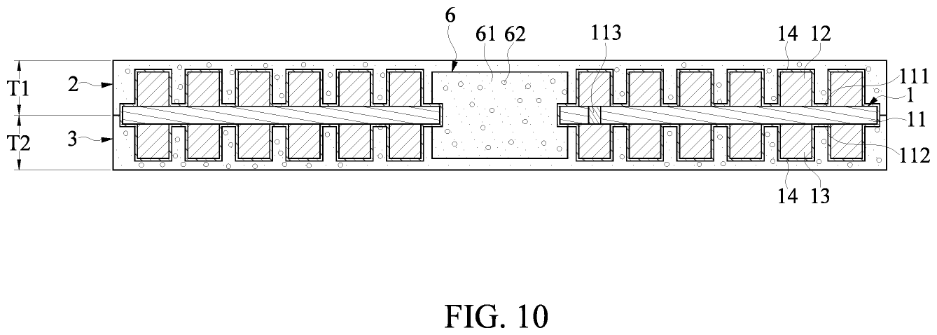

Reference is made to FIG. 10, which is a sectional schematic view of a thin film inductor according to a fifth embodiment of the present disclosure. Compared FIG. 10 with FIG. 6, in the embodiment shown in FIG. 10, the third magnetic layer 4 and the fourth magnetic layer 5 can be omitted. To be more specific, the magnetic core 6 is disposed between the first and second magnetic layers 2, 3, and located in the through hole 110 of the substrate 11. The first and second conductive wires 12, 13 are disposed on the substrate 11 and surround the through hole 110. Furthermore, the composition of the first magnetic layer 2 is the same as that of the second magnetic layer 3, but different from that of the magnetic core 6.

Furthermore, the first magnetic layer 2 includes a first filler 21 and a plurality of first particles 22 disposed in the first filler 21, the second magnetic layer 3 includes a second filler 31 and a plurality of second particles 32 disposed in the second filler 31, and the magnetic core 6 includes a fifth filler 61 and a plurality of fifth particles 62 disposed in the fifth filler 61, in which the size of each of the fifth particles 62. Furthermore, it should be noted that the coil assembly 1, the structures of the first magnetic layer 2, and the second magnetic layer 3 shown in FIG. 10 are the same as or similar to those shown in FIG. 6, and will not be reiterated herein.

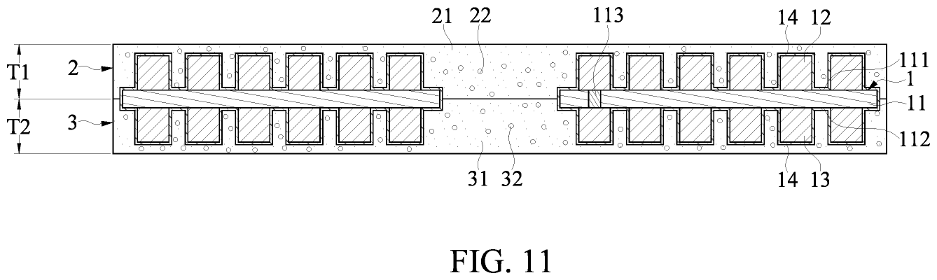

Subsequently, referring to FIG. 11, FIG. 11 is a sectional schematic view of a thin film inductor according to a sixth embodiment of the present disclosure. Compared FIG. 11 with FIG. 2, it can be observed that in the embodiment shown in FIG. 11, the third and fourth magnetic layers 4, 5 can be omitted. Furthermore, it should be noted that the structures of the first magnetic layer 2, and the second magnetic layer 3 shown in FIG. 11 are the same as or similar to those shown in FIG. 2 or FIG. 3, and will not be reiterated herein.

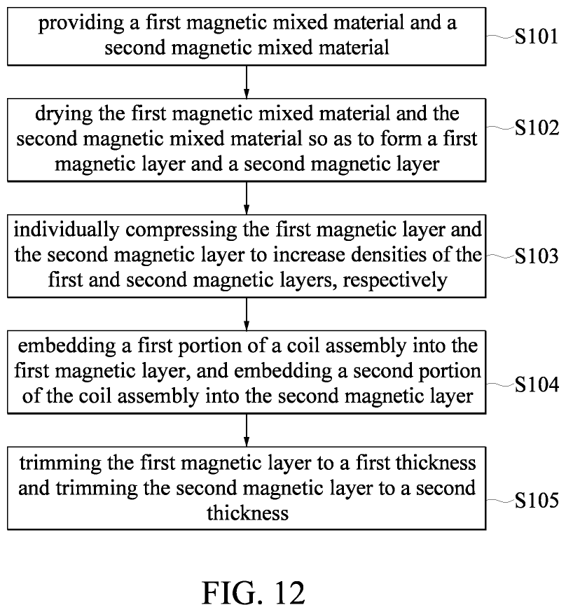

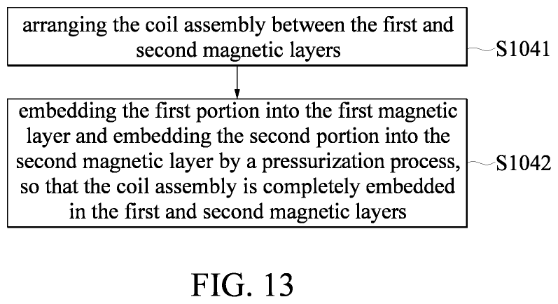

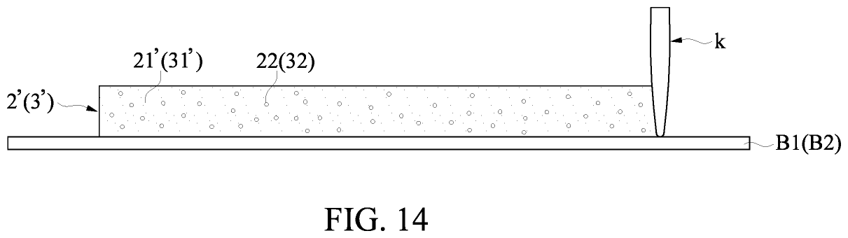

Reference is made to FIG. 12 to FIG. 17. FIG. 12 is a flowchart of a manufacturing method of a thin film inductor according to a first embodiment of the present disclosure. FIG. 13 is a schematic view of the thin film inductor in step S104 of the manufacturing method according to the first embodiment of the present disclosure. FIG. 14 to FIG. 17 are schematic views of the thin film inductor respectively showing different steps in the manufacturing method according to the first embodiment of the present disclosure. It should be noted that the thin film inductor U of the sixth embodiment shown in FIG. 11 is taken as an example for describing the manufacturing method shown in FIG. 12, and the features of each component of the thin film inductor U have been described previously, and will not be reiterated herein.

Subsequently, referring to FIG. 12 and FIG. 14, in the step S101, a first magnetic mixed material 2′ and a second magnetic mixed material 3′ are provided. For example, each of the first magnetic mixed material 2′ and the second magnetic mixed material 3′ can be in the form of a paste. That is to say, the first magnetic layer 2 and the second magnetic layer 3 respectively exist as the first magnetic mixed material 2′ and the second magnetic mixed material 3′ prior to being cured. Moreover, for example, the first magnetic mixed material 2′ includes a first filler 21′ that is not yet cured and a plurality of first particles 22 disposed therein, and the second magnetic mixed material 3′ includes a second filler 31′ that is not yet cured and a plurality of second particles 32 disposed therein. It should be noted that the materials and properties of the first filler 21, the first particles 22, the second filler 31, and the second particles 32 have been mentioned in the previous descriptions, and will not be reiterated herein. In addition, for example, in the step of providing the first and second magnetic mixed materials 2′, 3′, the first magnetic mixed material 2′ can be formed on a first carrier board B1 by performing screen printing or stencil printing with a squeegee blade k, and the second magnetic mixed material 3′ can be formed on a second carrier board B2 by using a squeegee blade k, but the present disclosure is not limited thereto.

Subsequently, in the step S102, the first magnetic mixed material 2′ and the second magnetic mixed material 3′ are dried to respectively form a first magnetic layer 2 and a second magnetic layer 3. For example, the first magnetic mixed material 2′ and the second magnetic mixed material 3′ can be dried by means of natural drying, light drying, or thermal drying (for example, but not limited to, baking), so as to form the cured and/or shaped first magnetic layer 2 and the second magnetic layer 3. Furthermore, by controlling viscosities and volumes of the first and second magnetic mixed materials 2′, 3′, the thicknesses and the shapes of the first and second magnetic layers 2, 3 can be controlled.

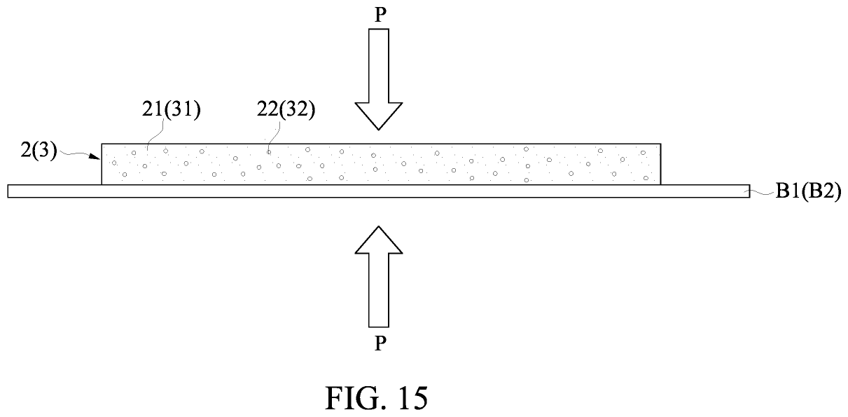

Subsequently, referring to FIGS. 12 and 15, in the step S103, after the step of drying the first magnetic mixed material 2′ and the second magnetic mixed material 3′ to respectively form the first magnetic layer 2 and the second magnetic layer 3, the method further includes a step of individually compressing the first magnetic layer 2 and the second magnetic layer 3 to increase densities of the first and second magnetic layers 2, 3, respectively. For example, a pressure P can be applied to the first and second magnetic layers 2, 3 by a water pressing process or an oil pressing process, so as to increase the densities of the first and second magnetic layers 2, 3, and modify the characteristics of the thin film inductor U. In one embodiment, by individually compressing the first magnetic layer 2 and the second magnetic layer 3, the first and second magnetic layers 2, 3 can have different densities, respectively. Furthermore, it should be noted that in the present disclosure, the step S103 is optional, and the step S103 may be omitted in another embodiment.

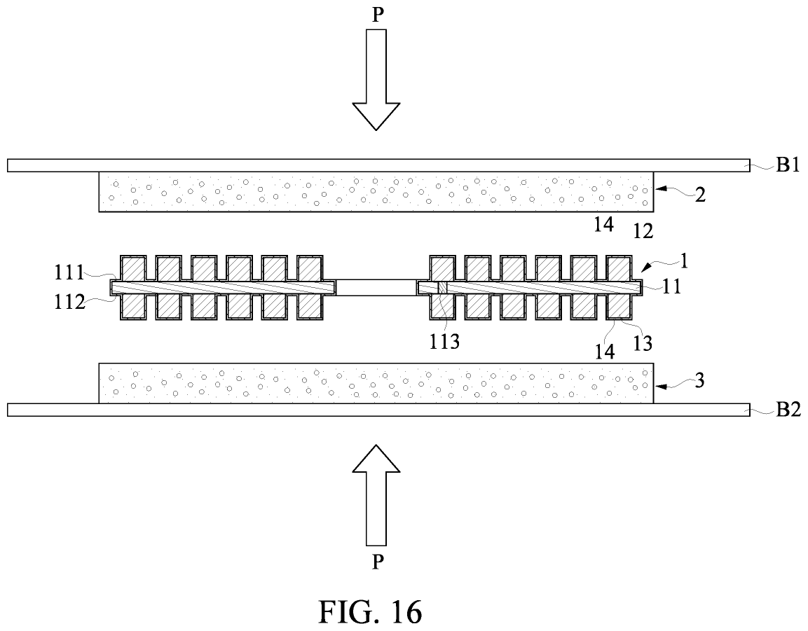

Referring to FIG. 12 and FIG. 16, in the step S104, a first portion (such as the first conductive wire 12) of a coil assembly 1 is embedded into the first magnetic layer 2, and a second portion (such as the second conductive wire 13) of the coil assembly 1 is embedded into the second magnetic layer 3. Furthermore, the coil assembly 1 can include the substrate 11, the first conductive wire 12, and the second conductive wire 13. The structure of the coil assembly 1 can be similar to that of the aforementioned embodiment, and will not be reiterated herein. Furthermore, in steps S1041 and 1042, the step of embedding the coil assembly 1 into the first and second magnetic layers 2, 3 can includes: disposing the coil assembly 1 between the first and second magnetic layers 2, 3; and embedding the first portion and the second portion of the coil assembly into the first magnetic layer 2 and the second magnetic layer 3, respectively, by a pressing process, so that the coil assembly 1 can be completely embedded in the first and second magnetic layers 2, 3. Furthermore, for example, the pressing process can be an oil pressing process, a water pressing process, or a cold pressing process, and so on, so that the first portion and the second portion of the coil assembly 1 are respectively embedded into the first and second magnetic layers 2, 3. That is, by applying a pressure P, the coil assembly 1 can be embedded in the first and second magnetic layers 2, 3, but the means for embedding the coil assembly 1 is not limited in the present disclosure.

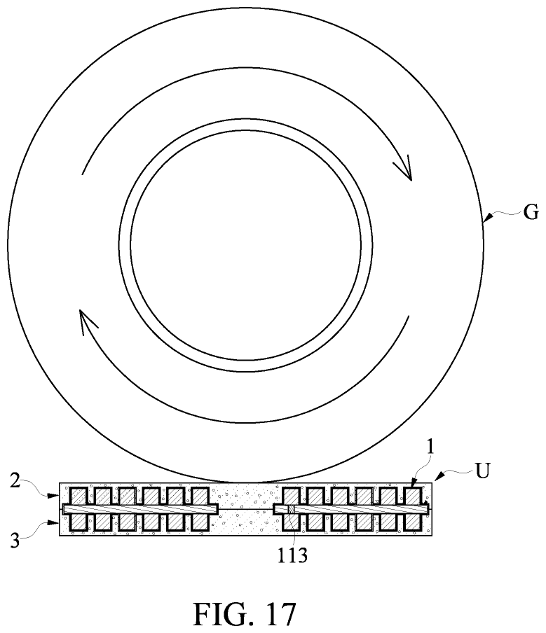

Subsequently, referring to FIG. 12 and FIG. 17, in the step S105, after the step of respectively embedding the first portion and the second portion of the coil assembly into the first magnetic layer 2 and the second magnetic layer 3, the method further includes: trimming the first magnetic layer 2 to a first thickness T1 and trimming the second magnetic layer 3 to a second thickness T2. That is to say, during the step S105, a total thickness and a surface flatness of the thin film inductor U can be adjusted. For example, during the step of trimming the first magnetic layer 2 to a first thickness T1 and trimming the second magnetic layer 3 to a second thickness T2, a grinding wheel G can be used to grind the first and second magnetic layers 2, 3, such that the first thickness T1 of the first magnetic layer 2 and the second thickness T2 of the second magnetic layer 3 can be adjusted, but the present disclosure is not limited thereto. Furthermore, it should be noted that in the present disclosure, the step S105 is optional, and in another embodiment, the step S105 can be omitted.

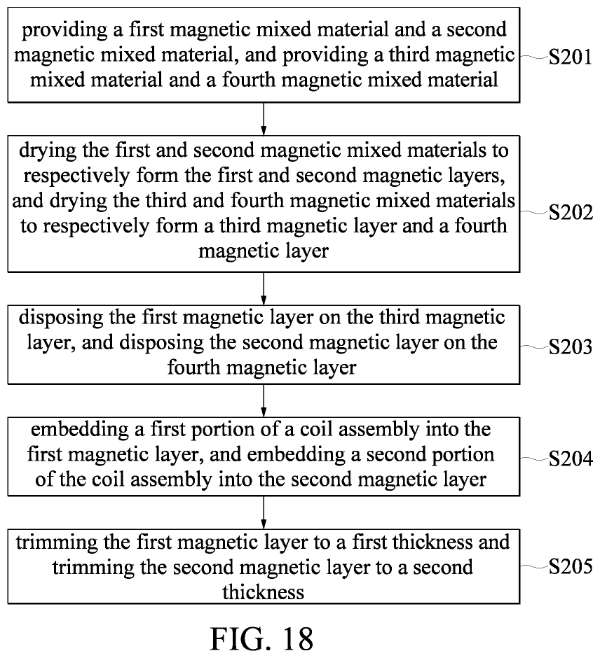

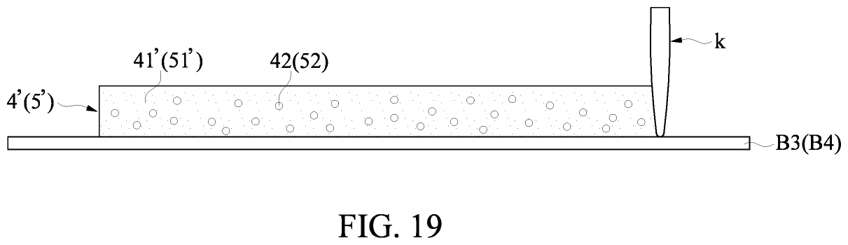

Reference is made to FIG. 18 to FIG. 21, which is to be read in conjunction with FIG. 12. FIG. 18 is a flowchart of a manufacturing method of a thin film inductor according to a second embodiment of the present disclosure. FIG. 19 to FIG. 21 are schematic views of the thin film inductor during the manufacturing method according to the second embodiment of the present disclosure. The greatest difference between the second embodiment and the first embodiment is that a third magnetic layer 4 and a fourth magnetic layer 5 are further provided to form the thin film inductor U. It should be noted that in the manufacturing method of the thin film inductor U provided in the instant embodiment, the features of each component are similar to those in the previous embodiment, and will not be reiterated herein. Furthermore, the thin film inductor U shown in FIG. 1, FIG. 2 or FIG. 5 is taken as an example for describing the manufacturing method of the second embodiment.

Subsequently, referring to FIG. 18 and FIG. 19, in the step S201, a first magnetic mixed material 2′ and a second magnetic mixed material 3′ are provided, and a third magnetic mixed material 4′ and a fourth magnetic mixed material 5′ are provided. For example, each of the third and fourth magnetic mixed materials 4′, 5′ can be in the form of a paste. That is to say, the third magnetic layer 4 and the fourth magnetic layer 5 respectively exist as the third magnetic mixed material 4′ and the fourth magnetic mixed material 5′ prior to being cured. Furthermore, for example, the third magnetic mixed material 4′ includes a third filler 41′ that is not yet cured and a plurality of third particles 42 disposed therein, and the fourth magnetic mixed material 5′ includes a fourth filler 51′ that is not yet cured and a plurality of fourth particles 52 disposed therein. It should be noted that the materials and properties of the third filler 41, the third particles 42, the fourth filler 51, and the fourth particles 52 have been mentioned in the above descriptions, and will not be reiterated herein. In addition, for example, in the step of providing the third and fourth magnetic mixed materials 4′, 5′, the fourth magnetic mixed material 4′ can be formed on a third carrier board B3 by performing screen printing or stencil printing with a squeegee blade k, and the fourth magnetic mixed material 5′ can be formed on a fourth carrier board B4 by using a squeegee blade k, but the present disclosure is not limited thereto.

Subsequently, in the step S202, the first magnetic mixed material 2′ and the second magnetic mixed material 3′ are dried to respectively form a first magnetic layer 2 and a second magnetic layer 3, and the third magnetic mixed material 4′ and the fourth magnetic mixed material 5′ are dried to respectively form the third magnetic layer 4 and the fourth magnetic layer 5. For example, the first magnetic mixed material 2′, the second magnetic mixed material 3′, the third magnetic mixed material 4′ and the fourth magnetic mixed material 5′ can be dried by means of natural drying or thermal drying (for example, but not limited to, baking), so as to dry and/or shape the first magnetic layer 2, the second magnetic layer 3, the third magnetic layer 4, and the fourth magnetic layer 5. Furthermore, by controlling viscosities and volumes of the first, second, third and fourth magnetic mixed materials 2′, 3′, 4′, 5′, the thickness and the shape of each of the first, second, third and fourth magnetic layers 2, 3, 4, 5 can be controlled.

Furthermore, it should be noted that in the second embodiment, the means as provided in the step S103 can be utilized to individually compress the first magnetic layer 2, the second magnetic layer 3, the third magnetic layer 4, and the fourth magnetic layer 5, so as to increase densities of the first magnetic layer 2, the second magnetic layer 3, the third magnetic layer 4, and the fourth magnetic layer 5, respectively. However, whether or not the first magnetic layer 2, the second magnetic layer 3, the third magnetic layer 4, and the fourth magnetic layer 5 are compressed is not limited in the present disclosure. Furthermore, by individually compressing the first to fourth magnetic layers 2-5, the first to fourth magnetic layers 2-5 can have different densities, respectively. That is to say, when the magnetic layers (the first to fourth magnetic layers 2-5) are required to have different characteristics, by individually compressing the magnetic layers, the densities of the magnetic layers can be adjusted individually, such that the magnetic layers have different permeability values, respectively.

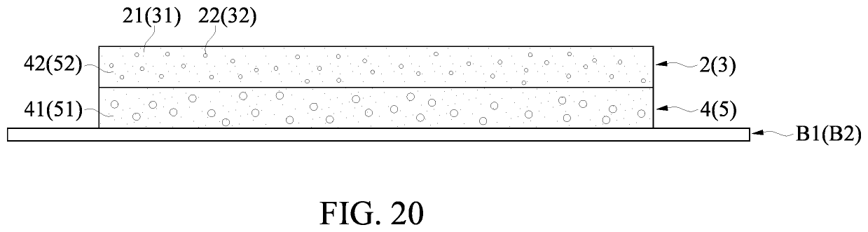

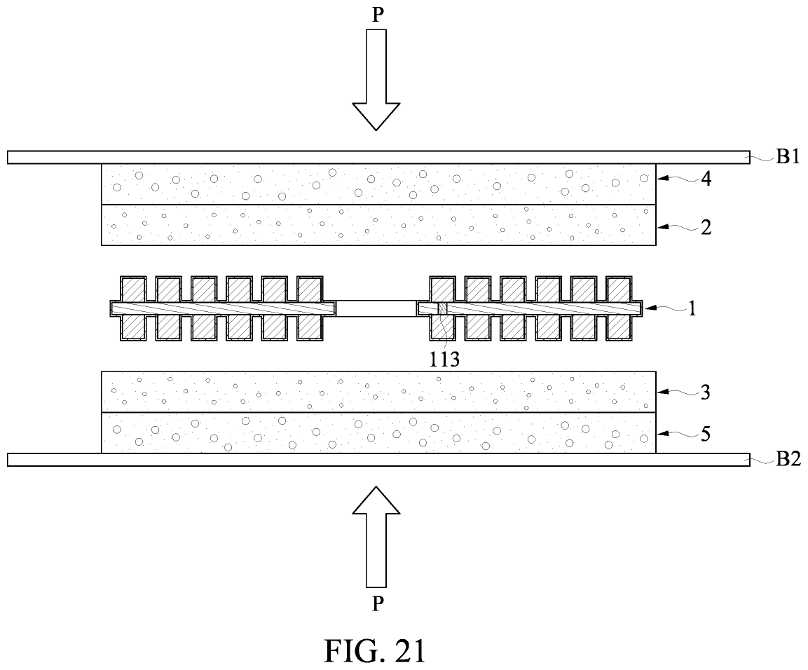

Reference is made to FIG. 20 and FIG. 21. In the step S203, the first magnetic layer 2 is disposed on the third magnetic layer 4, and the second magnetic layer 3 is disposed on the fourth magnetic layer 5. For example, the first magnetic layer 2 is disposed between the first portion of the coil assembly 1 and the third magnetic layer 4, and the second magnetic layer 3 is disposed between the second portion of the coil assembly 1 and the fourth magnetic layer 5. Furthermore, it is worth mentioning that in another embodiment, more magnetic layers (such as a fifth magnetic layer, a sixth magnetic layer, a seventh magnetic layer or an eighth magnetic layer, and so on, that is not shown in the figures) can be provided, and every two of the magnetic layers that is paired with each other can be respectively arranged at two opposite sides of the coil assembly 1 and sequentially stacked. In other words, in the present disclosure, two magnetic layers located at two sides of the coil assembly 1 are taken as an example for description, but in another embodiment, three or more than four magnetic layers can be disposed at each side of the coil assembly 1, and the number of the magnetic layers is not limited in the present disclosure.

Reference is made to FIG. 21. As mentioned above, in the step S204, a first portion of a coil assembly 1 is embedded into the first magnetic layer 2, and a second portion of the coil assembly 1 is embedded into the second magnetic layer 3. As such, the first magnetic layer 2 and the second magnetic layer 3 jointly form a middle layer (which is formed by combining the first magnetic layer 2 with the second magnetic layer 3) relative to the third magnetic layer 4 and the fourth magnetic layer 5. The third magnetic layer 4 and the fourth magnetic layer 5 respectively serve as two outer covering layers that are located at the outside of the thin film inductor U.

It should be noted that in the step S203, the first thickness T1 of the first magnetic layer 2 and the second thickness T2 of the second magnetic layer 3 can be adjusted so as to form different thin film inductors U having different structures after performing the step S204. For example, when the first thickness T1 of the first magnetic layer 2 may be 2 to 2.5 times that of the first portion (the first conductive wire 12), and the second thickness T2 of the second magnetic layer 3 may be 2 to 2.5 times that of the second portion (second conductive wire 13), the thin film inductor U shown in FIG. 2 can be fabricated. When the first thickness T1 of the first magnetic layer 2 may be 1 to 1.5 times that of the first portion (the first conductive wire 12), and the second thickness T2 of the second magnetic layer 3 may be 1 to 1.5 times that of the second portion (second conductive wire 13), the thin film inductor U shown in FIG. 5 can be fabricated.

Subsequently, in the step S205, the third magnetic layer 4 is trimmed to a third thickness T3 and the fourth magnetic layer 5 is trimmed to a fourth thickness T4, i.e., the outer covering layers of the thin film inductor U can be trimmed. That is to say, by any grinding means that has been described in the previous embodiment, the third magnetic layer 4 can be trimmed to the third thickness T3 and the fourth magnetic layer 5 can be trimmed to the fourth thickness T4, but the present disclosure is not limited thereto. Furthermore, it should be noted that in the present disclosure, the step S205 is optional, and can be omitted in another embodiment. Furthermore, it is worth mentioning that when the thin film inductor U further includes more magnetic layers (such as a fifth magnetic layer, a sixth magnetic layer, a seventh magnetic layer or an eighth magnetic layer, and so on, that is not shown in the figures), in the step S205, the outer covering layers of the thin film inductor U, i.e., the outermost magnetic layers respectively located at two opposite sides of the thin film inductor U, are trimmed.

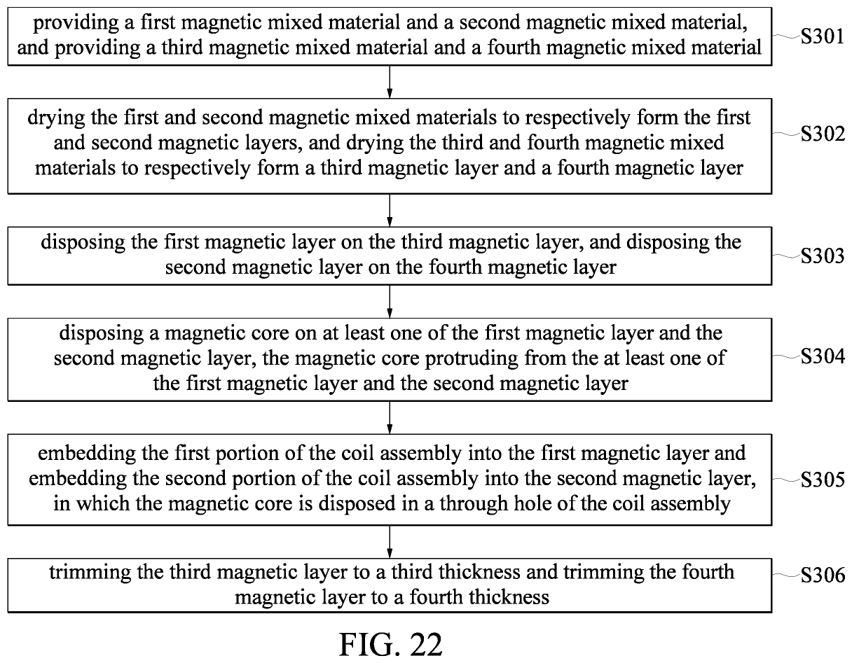

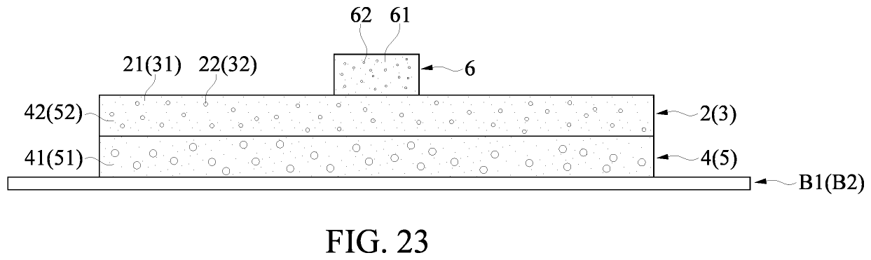

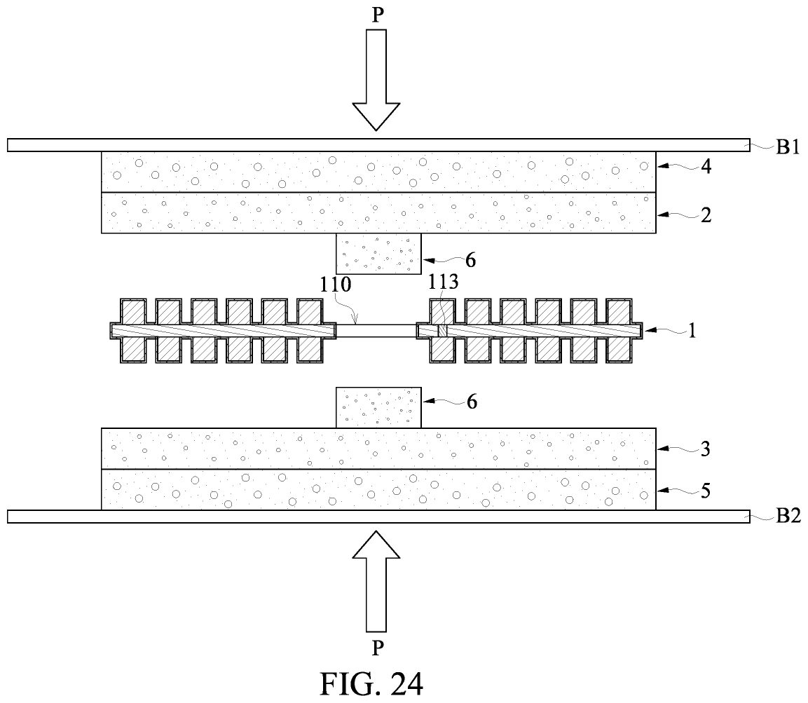

Reference is made to FIGS. 22 to 24. FIG. 22 is a flowchart of a manufacturing method of a thin film inductor according to a third embodiment of the present disclosure. FIG. 23 and FIG. 24 are schematic views of the thin film inductor during the manufacturing method according to the third embodiment of the present disclosure. It should be noted that the features of each component of the thin film inductor U provided in the instant embodiment are similar to those in the aforementioned embodiment, and will not be reiterated herein. Furthermore, the thin film inductor U shown in FIG. 6 or FIG. 7 is taken as an example for describing the manufacturing method of the third embodiment. That is to say, in the third embodiment, on the basis of the second embodiment, a magnetic core 6 is further provided.

Reference is made to FIG. 14, FIG. 19, and FIG. 20. In the step S301, a first magnetic mixed material 2′ and a second magnetic mixed material 3′ are provided, and a third magnetic mixed material 4′ and a fourth magnetic mixed material 5′ are provided. In the step S302, the first magnetic mixed material 2′ and the second magnetic mixed material 3′ are dried to respectively form a first magnetic layer 2 and a second magnetic layer 3, and the third magnetic mixed material 4′ and the fourth magnetic mixed material 5′ are dried to respectively form the third magnetic layer 4 and the fourth magnetic layer 5. In the step S303, the first magnetic layer 2 is disposed on the third magnetic layer 3, and the second magnetic layer 3 is disposed on the fourth magnetic layer 5. Furthermore, the abovementioned steps S301, S302 and S303 are similar to the steps S201, S202, and S203, and not be reiterated herein.

Subsequently, referring to FIG. 23, in the step S304, a magnetic core 6 is disposed on the first magnetic layer 2 and/or the second magnetic layer 3, and the magnetic core 6 protrudes from the first magnetic layer 2 and/or the second magnetic layer 3. In the third embodiment, a situation where a portion of the magnetic core 6 is disposed on the first magnetic layer 2, and another portion of the magnetic core 6 is disposed on the second magnetic layer 3 is taken as an example for description, but the present disclosure is not limited thereto. It is worth mentioning that in one embodiment, the magnetic core 6 can be disposed on the first magnetic layer 2 and/or second magnetic layer 3 by performing screen printing, but the present disclosure is not limited thereto. Moreover, the magnetic core 6 can be made of a fifth magnetic mixed material (which is not illustrated in the figures), and the fifth magnetic mixed material can be in the form of a paste. In other words, the magnetic core 6 exists as the fifth magnetic mixed material prior to being cured. Furthermore, for example, the magnetic core 6 includes a fifth filler 61 and a plurality of fifth particles 62 disposed in the fifth filler 61. It should be noted that the materials and properties of the fifth filler 61 and fifth particles 62 have been mentioned in the previous embodiments, and will not be reiterated herein.

Subsequently, referring to FIG. 24, in the step S305, a first portion of a coil assembly 1 is embedded into the first magnetic layer 2, a second portion of the coil assembly 1 is embedded into the second magnetic layer 3, and the magnetic core 6 is disposed in a through hole 110 of the coil assembly 1. For example, since the magnetic core 6 protrudes from the first magnetic layer 2 and/or the second magnetic layer 3, during the step of embedding the coil assembly 1 into the first and second magnetic layers 2, 3, the magnetic core 6 can be filled into the through hole 110 of the coil assembly 1. It is worth mentioning that the material, the thickness, and the shape of a protrusion of the magnetic core 6 can be adjusted based on required characteristics of products, a size of the coil and a material of the substrate. The present disclosure focuses on the implementation method and is not limited thereto.

It should be noted that by adjusting a sum of the thicknesses of the two portions of the magnetic core 6 that are respectively disposed on the first and second magnetic layers 2, 3, after the step S305 is performed, different thin film inductors U with different structures can be fabricated. For example, when one of the portions of the magnetic core 6 has thickness that is 0.8 to 1 times that of the first portion (the first conductive wire 12), the thin film inductor U shown in FIG. 6 can be fabricated. When one of the portions of the magnetic core 6 has the thickness that is 1 to 1.5 times that of the first portion (the first conductive wire 12), the thin film inductor U shown in FIG. 7 can be fabricated.

Subsequently, in the step S306, the third magnetic layer 4 is trimmed to a third thickness T3, and the fourth magnetic layer 5 is trimmed to a fourth thickness T4. That is to say, the outer covering layers of the thin film inductor U that are respectively located at the outermost sides of the film inductor U are trimmed. That is to say, by performing the step S306, the entire thickness and the surface flatness of the thin film inductor U can be modified. Furthermore, it should be noted that in the present embodiment, the step S306 is optional and can be omitted in another embodiment.

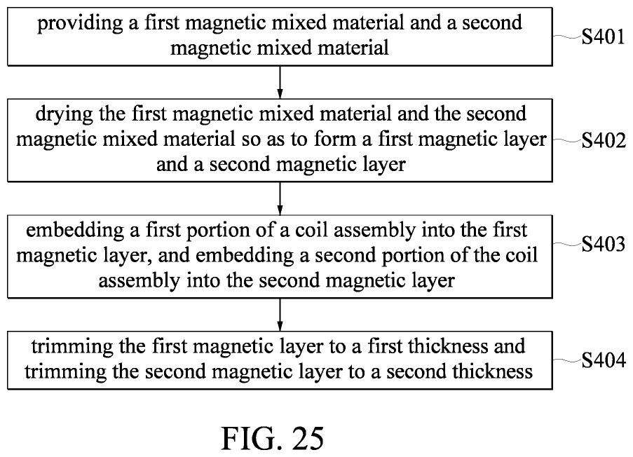

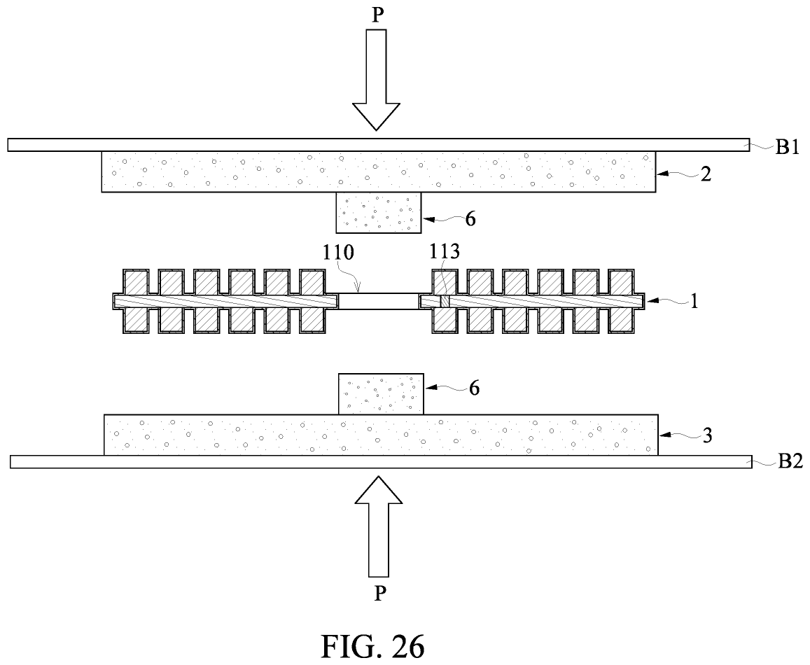

Reference is made to FIG. 14 again, which is to be read in conjunction with FIG. 25 and FIG. 26. FIG. 25 is a flowchart of a manufacturing method of a thin film inductor according to a fourth embodiment of the present disclosure. FIG. 26 is a schematic view of the thin film inductor during the manufacturing method according to the fourth embodiment of the present disclosure. It should be noted that the features of each component of the thin film inductor U that is fabricated by the manufacturing method in the fourth embodiment are similar to those in the aforementioned embodiments, and will not be reiterated herein. Furthermore, the thin film inductor U shown in FIG. 10 is taken as an example for describing the manufacturing method of the instant embodiment.

Reference is made to FIG. 14, FIG. 25, and FIG. 26. In the step S401, a first magnetic mixed material 2′ and a second magnetic mixed material 3′ are provided. In the step S402, the first magnetic mixed material 2′ and the second magnetic mixed material 3′ are dried to respectively form a first magnetic layer 2 and a second magnetic layer 3. Furthermore, the abovementioned steps S401 and S402 are similar to the steps S101 and S102, and will not be reiterated herein.

Subsequently, referring to FIG. 26, in the step S403, a first portion of a coil assembly 1 is embedded into the first magnetic layer 2, a second portion of the coil assembly 1 is embedded into the second magnetic layer 3, and a magnetic core 6 is disposed in a through hole 110 of the coil assembly 1. That is to say, before the step of disposing the magnetic core 6 in the through hole 110 of the coil assembly 1, the magnetic core 6 can be disposed on the first magnetic layer 2 and/or the second magnetic layer 3, and the magnetic core 6 protrudes from the first magnetic layer 2 and/or the second magnetic layer 3. Subsequently, the magnetic core 6 can be disposed in the through hole 110 of the coil assembly 1 by a compression process. However, in another embodiment, the magnetic core 6 can be directly disposed in the through hole 110, and thereafter the magnetic core 6, the first magnetic layer 2, and the second magnetic layer 3 are combined with one another by the compression process. Furthermore, it should be noted that the structural feature of the magnetic core 6 is similar to that in the aforementioned embodiment, and will not be reiterated herein.

Subsequently, in the step S404, the first magnetic layer 2 is trimmed to a first thickness T1 and the second magnetic layer 3 is trimmed to a second thickness T2. That is to say, the entire thickness and surface flatness of the thin film inductor U can be modified by performing the step S404. Furthermore, it should be noted that in the present disclosure, the step S404 is optional, and can be omitted in another embodiment.

### Beneficial Effects of Embodiments

In conclusion, one of the advantages of the present disclosure is that in the thin film inductor U provided herein, by virtue of “a part of the first magnetic layer filling into a gap defined between any two adjacent ones of the winding turns of the first conductive wire, and a part of the second magnetic layer filling into a gap defined between any two adjacent ones of the winding turns of the second conductive wire,” the thin film inductor U can have a greater inductance value and a higher saturation current.

Furthermore, by virtue of “at least two of the first magnetic layer 2, the second magnetic layer 3, the third magnetic layer 4, and the fourth magnetic layer 5 having different compositions” or “at least two of the first magnetic layer 2, the second magnetic layer 3, and the magnetic core 6 having different compositions,” the thin film inductor U can includes two or more combinations of material systems. As such, the composition of each magnetic layer can be designed according to the requirements of the practical products, which is not only beneficial to customization, but results in improvement of the thin film inductor U in characteristics and quality.

Furthermore, by virtue of “the first magnetic layer 2 and the second magnetic layer 3 respectively having a first curved surface 2s and a second curved surface 3s,” the inductance value and the saturation current of the thin film inductor U can be further improved, such that the thin film inductor U has better characteristics.

Furthermore, in the manufacturing method of the thin film inductor U in the present disclosure, by virtue of “drying the first magnetic mixed material 2′ and the second magnetic mixed material 3′ to respectively form the first magnetic layer 2 and the second magnetic layer 3; and embedding a first portion of a coil assembly 1 in the first magnetic layer 2 and embedding a second portion of the coil assembly 1 in the second magnetic layer 3,” the fabrication efficiency, the characteristics and the quality of the thin film inductor can be improved.

To be more specifically, by controlling viscosities and volumes of the first, second, third, and fourth magnetic mixed materials 2′-5′, the thicknesses and the shapes of the first, second, third, and fourth magnetic layers 2-5 can be controlled. Furthermore, the first, second, third, and fourth magnetic mixed materials 2′-5′ can be dried at the same time, so as to form the first, second, third, and fourth magnetic layers 2-5 to improve the fabrication efficiency of the magnetic layers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thin film inductor, comprising:
a coil assembly including a substrate, a first conductive wire disposed on a first surface of the substrate, and a second conductive wire disposed on a second surface of the substrate, wherein the first conductive wire and the second conductive wire each have a plurality of winding turns;
a first magnetic layer disposed on the first surface, wherein the first conductive wire is embedded in the first magnetic layer, and a part of the first magnetic layer fills into a gap defined between any two adjacent ones of the winding turns of the first conductive wire;
a second magnetic layer disposed on the second surface, wherein the second conductive wire is embedded in the second magnetic layer, and a part of the second magnetic layer fills into a gap defined between any two adjacent ones of the winding turns of the second conductive wire;
a third magnetic layer disposed on the first magnetic layer, wherein the first magnetic layer is disposed between the substrate and the third magnetic layer; and
a fourth magnetic layer disposed on the second magnetic layer, wherein the second magnetic layer is disposed between the substrate and the fourth magnetic layer;
wherein at least two of the first magnetic layer, the second magnetic layer, the third magnetic layer, and the fourth magnetic layer have different compositions.

2. The thin film inductor according to claim 1, wherein a permeability value of the first magnetic layer is smaller than a permeability value of the third magnetic layer, and a permeability value of the second magnetic layer is smaller than a permeability value of the fourth magnetic layer.

3. The thin film inductor according to claim 1, further comprising: a magnetic core disposed between the first magnetic layer and the second magnetic layer and located in a through hole of the substrate, wherein the first conductive wire and the second conductive wire are disposed on the substrate and surround the through hole.

4. The thin film inductor according to claim 1, wherein the first magnetic layer includes a first filler and a plurality of first particles disposed in the first filler, the second magnetic layer includes a second filler and a plurality of second particles disposed in the second filler, a portion of the plurality of first particles are disposed in the gap defined between any two adjacent ones of the winding turns of the first conductive wire, and a portion of the plurality of second particles are disposed in the gap defined between any two adjacent ones of the winding turns of the second conductive wire.

5. The thin film inductor according to claim 1, wherein the coil assembly further includes an insulating layer covering the first conductive wire and the second conductive wire, wherein the gap defined between any two adjacent ones of the winding turns of the first and second conductive wires has a width greater than two times a thickness of the insulating layer.

6. The thin film inductor according to claim 5, wherein the insulating layer is formed by an atomic layer deposition, a molecular layer deposition, or a chemical vapor deposition process.

7. The thin film inductor according to claim 1, wherein the first magnetic layer and the second magnetic layer respectively have a first curved surface and a second curved surface, the first curved surface and the second curved surface are both concave surfaces recessed toward the substrate, and an orthogonal projection of the first curved surface overlaps with an orthogonal projection of second curved surface in a thickness direction of the substrate.

8. A thin film inductor, comprising:
a coil assembly including a substrate, a first conductive wire disposed on a first surface of the substrate, and a second conductive wire disposed on a second surface of the substrate, wherein the first conductive wire and the second conductive wire each have a plurality of winding turns;
a first magnetic layer disposed on the first surface, wherein the first conductive wire is embedded in the first magnetic layer, and a part of the first magnetic layer fills into a gap defined between any two adjacent ones of the winding turns of the first conductive wire;
a second magnetic layer disposed on the second surface, wherein the second conductive wire is embedded in the second magnetic layer, and a part of the second magnetic layer fills into a gap defined between any two adjacent ones of the winding turns of the second conductive wire;
a magnetic core disposed between the first magnetic layer and the second magnetic layer and located in a through hole of the substrate, wherein the first conductive wire and the second conductive wire are disposed on the substrate and surround the through hole.

9. The thin film inductor according to claim 8, wherein at least two of the first magnetic layer, the second magnetic layer, and the magnetic core have different compositions.

10. The thin film inductor according to claim 9, wherein the first magnetic layer includes a first filler and a plurality of first particles disposed in the first filler, the second magnetic layer includes a second filler and a plurality of second particles disposed in the second filler, and the magnetic core includes a fifth filler and a plurality of fifth particles disposed in the fifth filler, wherein a portion of the plurality of first particles are disposed in the gap defined between any two adjacent ones of the winding turns of the first conductive wire, and a portion of the plurality of second particles are disposed in the gap defined between any two adjacent ones of the winding turns of the second conductive wire.

11. The thin film inductor according to claim 8, wherein the first magnetic layer and the second magnetic layer respectively have a first curved surface and a second curved surface, the first curved surface is a convex surface protruding from the first conductive wire, the second curved surface is another convex surface protruding from the second conductive wire, and orthogonal projections of the first curved surface, the second curved surface and the magnetic core overlap with one another in a thickness direction of the substrate.

12. A manufacturing method of a thin film inductor, comprising:
providing a first magnetic mixed material and a second magnetic mixed material;
drying the first magnetic mixed material and the second magnetic mixed material so as to form a first magnetic layer and a second magnetic layer; and
embedding a first portion of a coil assembly into the first magnetic layer, and embedding a second portion of the coil assembly into the second magnetic layer, wherein the first portion and the second portion each have a plurality of winding turns, a part of the first magnetic layer fills into a gap defined between any two adjacent ones of the winding turns of the first portion, and a part of the second magnetic layer fills into a gap defined between any two adjacent ones of the winding turns of the second portion.

13. The manufacturing method according to claim 12, wherein the step of embedding the coil assembly into the first and second magnetic layers includes:
arranging the coil assembly between the first and second magnetic layers; and
embedding the first portion of the coil assembly into the first magnetic layer and embedding the second portion of the coil assembly into the second magnetic layer by a pressing process, so that the coil assembly is completely embedded in the first and second magnetic layers.

14. The manufacturing method according to claim 12, further comprising:
after the step of embedding the first portion of the coil assembly into the first magnetic layer and embedding the second portion of the coil assembly into the second magnetic layer, trimming the first magnetic layer to a first thickness and trimming the second magnetic layer to a second thickness by a grinding process.

15. The manufacturing method according to claim 12, further comprising:
after the step of drying the first magnetic mixed material and the second magnetic mixed material to respectively form the first magnetic layer and the second magnetic layer, individually compressing the first magnetic layer and the second magnetic layer to increase densities of the first and second magnetic layers, respectively.

16. The manufacturing method according to claim 12, further comprising:
before the step of embedding the first portion of the coil assembly into the first magnetic layer, and embedding the second portion of the coil assembly into the second magnetic layer, disposing the first magnetic layer on a third magnetic layer, and disposing the second magnetic layer on a fourth magnetic layer, wherein the first magnetic layer is disposed between the first portion of the coil assembly and the third magnetic layer, and the second magnetic layer is disposed between the second portion of the coil assembly and the fourth magnetic layer.

17. The manufacturing method according to claim 16, wherein the step of providing the first magnetic mixed material and the second magnetic mixed material further includes: providing a third magnetic mixed material and a fourth magnetic mixed material; wherein the step of drying the first and second magnetic mixed materials further includes: drying the third and fourth magnetic mixed materials to respectively form a third magnetic layer and a fourth magnetic layer.

18. The manufacturing method according to claim 16, further comprising:
before the step of embedding the first portion of the coil assembly into the first magnetic layer and embedding the second portion of the coil assembly into the second magnetic layer, disposing a magnetic core on at least one of the first magnetic layer and the second magnetic layer, wherein the magnetic core protrudes from the at least one of the first magnetic layer and the second magnetic layer;
wherein in the steps of embedding the first portion of the coil assembly into the first magnetic layer and embedding the second portion of the coil assembly into the second magnetic layer, the magnetic core is disposed in a through hole of the coil assembly.

19. The manufacturing method according to claim 12, wherein in the step of embedding the first portion of the coil assembly into the first magnetic layer, and embedding the second portion of the coil assembly into the second magnetic layer, a magnetic core is disposed in a through hole of the coil assembly.

20. The manufacturing method according to claim 12, wherein the first magnetic layer has a first curved surface, the second magnetic layer has a second curved surface, and the first curved surface is a concave surface recessed toward a substrate or a convex surface protruding from the first portion of the coil assembly, and the second curved surface is a concave surface recessed toward the substrate or a convex surface protruding from the second portion of the coil assembly.
